(19) United States
(12) Patent Application Publication
(10) Pub. No.: US 2024/0080505 A1
(43) Pub. Date: Mar. 7, 2024

(54) METHOD AND NON-TRANSITORY COMPUTER-READABLE MEDIUM

(71) Applicant: 17LIVE Japan Inc., Tokyo (JP)

(72) Inventors: Yung-Chi HSU, Taipei City (TW); Hsing-Yu TSAI, Taipei City (TW); Chia-Han CHANG, Taipei City (TW); Yi-Jou LEE, Taipei City (TW); Ming-Che CHENG, Taipei City (TW)

(21) Appl. No.: 18/340,541

(22) Filed: Jun. 23, 2023

(30) Foreign Application Priority Data
Sep. 1, 2022 (JP) 2022-138965

(51) Int. Cl. H04N 21/2187; H04N 21/43; H04N 21/431; H04N 21/433; H04N 21/442; H04N 21/4788

(52) U.S. Cl. CPC H04N 21/2187; H04N 21/4302; H04N 21/4312; H04N 21/433; H04N 21/442; H04N 21/4788

(57) ABSTRACT

A method, comprising: detecting an outage of at least one functionality in a live streaming; performing an first operation toward a second user terminal; storing data of the first operation in a database of the first user terminal; and displaying an effect corresponding to the first operation during the outage. The present disclosure may store the data of operation performed by the user terminal during outage and process the operation after the outage is recovered. Therefore, the streamers and viewers may feel interested and satisfied, instead of feeling anxious, and the user experience may be enhanced.

### CROSS-REFERENCE TO RELATED APPLICATIONS

This application is based on and claims the benefit of priority from Japanese Patent Application Serial No. 2022-138965 (filed on Sep. 1, 2022), the contents of which are hereby incorporated by reference in its entirety.

### TECHNICAL FIELD

This disclosure relates to information and communication technology, and in particular, to a computer program and a terminal for performing an operation during an outrage in a live streaming.

### BACKGROUND

Some APPs or platforms provide live streaming service for streamers and viewers to interact with each other. The streamers may have a performance to cheer up the viewer and the viewer may send gifts to support the streamers.

Sometimes the live streaming service may encounter problems such as outages because some functionality such as the gift sending function does not work appropriately for a short period of time. Patent Document 1 disclose a method to solve the problem of outage for the streamers and viewers.

However, the viewers and the streamers may feel annoyed during the outage even if the outage is recovered soon or not. This may lead to poor user experience. Therefore, how to improve the user experience is very important.

### SUMMARY

An embodiment of subject application relates to a method, comprising: detecting an outage of at least one functionality in a live streaming; performing an first operation toward a second user terminal; storing data of the first operation in a database of the first user terminal; and displaying an effect corresponding to the first operation during the outage.

Another embodiment of subject application relates to a method, comprising: detecting an outage of at least one functionality in a live streaming; receiving data of a first operation from a first user terminal; displaying a first effect corresponding to the first operation during the outage.

Another embodiment of subject application relates to a non-transitory computer-readable medium including program instructions, that when executed by one or more processors, cause the one or more processors to execute: detecting an outage of at least one functionality in a live streaming; performing an first operation toward a second user terminal; storing data of the first operation in a database of the first user terminal; and displaying an effect corresponding to the first operation during the outage.

The present disclosure may store the data of operation performed by the user terminal during outage and process the operation after the outage is recovered. Therefore, the streamers and viewers may feel interested and satisfied, instead of feeling anxious, and the user experience may be enhanced.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the terminal side gift DB 220 of FIG. 2;

FIG. 5 shows an exemplary data structure of the gift queue DB 222 of FIG. 2;

FIG. 6 shows an exemplary data structure of the stream DB 320 of FIG. 3;

FIG. 7 shows an exemplary data structure of the user DB 322 of FIG. 3;

FIG. 8 shows an exemplary data structure of the gift DB 324 of FIG. 3;

FIG. 9-FIG. 18 are exemplary screen images of a live-streaming room screen 610 shown on the display of the streamer user terminal 20 or the viewer user terminal 30;

FIG. 19 is a flowchart showing steps of an application activation process on the user terminals 20 and 30.

FIG. 20 is an exemplary sequence chart illustrating an operation of the configuration of the live streaming system 1 according to some embodiments of subject application.

FIG. 21 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and streamers in a technical way.

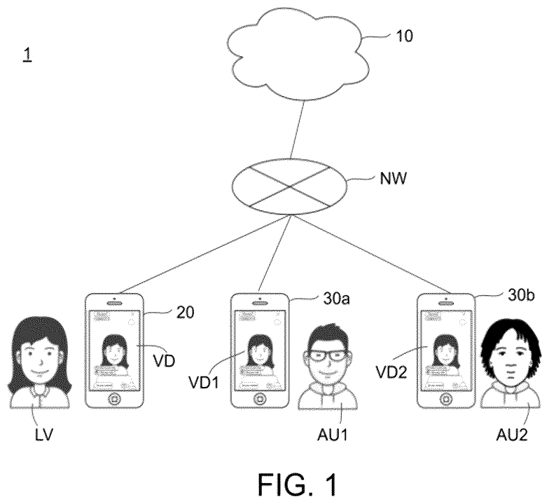

FIG. 1 shows a schematic configuration of a live streaming system 1 according to some embodiments of subject application. The live streaming system 1 provides a live streaming service for the streaming streamer (may also be referred as live or streamer) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a streamer and the user terminal 30 may be a viewer. In some embodiments, the streamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the streamer LV, the viewer AU, and APP provider (not shown), who provides the server 10. The streamer LV may record his/her own contents such as songs, talks, performance, game streaming or the like by his/her own user terminal 20 and upload to the server 10 and be the one who distributes contents in real time. In some embodiments, the streamer LV may interact with the viewer AU via the live streaming.

The APP provider may provide a platform for the contents to go on live streaming in the server 10. In some embodiments, the APP provider may be the media or manager to manage the real time communication between the streamer LV and viewer AU. The viewer AU may access the platform by the user terminal 30 to select and watch the contents he/she would like to watch. The viewer AU may perform operations to interact with the streamer, such as commenting or cheering the streamer, by the user terminal 30. The streamer, who provides the contents, may respond to the comment or cheer. The response of the streamer may be transmitted to the viewer AU by video and/or audio or the like. Therefore, a mutual communication among the streamer and viewer may be accomplished.

The “live streaming” in this specification may be referred to as the data transmission which enables the contents the streamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format. Web Real-Time Communications, Real-Time Messaging Protocol. MPEG DASH or the like. The live streaming may further include the embodiment that the viewer AU may reproduce or watch the contents with specific delay while the streamer is recording the contents. Regarding the magnitude of the delay, it should be at least small enough to enable the streamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the streamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the streamer and reproduced by the user terminal of the viewer via the server 10, the streaming data generated by the user terminal of the streamer, the streaming data passed through the server 10 and the streaming data received and reproduced by the by the user terminal of the viewer are all the same streaming data.

As shown in FIG. 1, the streamer LV is providing the live streaming. The user terminal 20 of the streamer generates the streaming data by recording his/her video and/or audio, and transmits to the server 10 via the network NW. At the same time, the user terminal 20 may display the video VD on the display of the user terminal 20 to check the streaming contents of the streamer LV.

The viewer AU1, AU2 of the user terminal 30a. 30b, who request the platform to provide the live streaming of the streamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the streamer LV, and the audio outputted from the terminal 30a. 30b may also be substantially the same as the audio recorded by the user terminal of the streamer LV.

The recording at the user terminal 20 of the streamer may be simultaneous with the reproducing of the streaming data at the user terminal 30a, 30b of the viewer AU1, AU2. If a viewer AU1 inputs a comment on the contents of the streamer LV into the user terminal 30a, the server 10 will display the comment on the user terminal 20 of the streamer in real time, and also display on the user terminal 30a, 30b of the viewer AU1, AU2 respectively. If the streamer LV responds to the comment, the response may be outputted as the text, image, video or audio from the terminal 30a, 30b of the viewer AU1, AU2, so that the communication of the streamer LV and viewer LV may be realized. Therefore, the live streaming system may realize the live streaming of two-way communication.

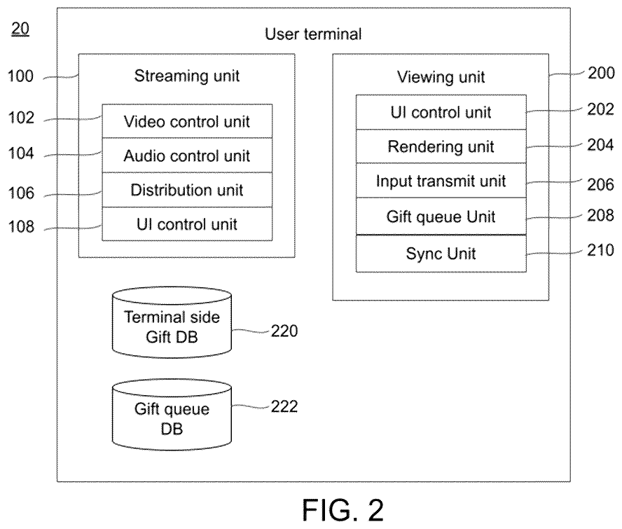

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The streamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an streamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the streamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the streamer.

The viewing unit 200 may include UI control unit 202, rendering unit 204, input transmit unit 206, gift queue unit 208 and sync unit 210. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing an user, voting in an event, gaming or the like. For example, the input transmit unit 206 may generate gift information and transmit to server 10 via the internet NW if the user terminal of the viewer clicks a gift object on the screen in order to send a gift to the streamer.

In some embodiments, the input transmit unit 206 may not be able to realize the gift sending function during an outage of the server 10 or the like. Here, the outage may be referred to as the user's inability to utilize some streaming or viewing services due to a software issue. In some embodiments, the software issue may occur due to mainly the server 10, or a third-party service used by the server 10 or the like. In some embodiments, the outage may occur on specific functions, such as gift sending function, in-app purchase function or the like. For example, the viewer may be able to go on live streaming and watch streaming, but not be able to send gifts, do in-app purchases, display gift effects, check remaining points, betting on a game or the like. Here, the gift sending function is taken as an example for explanation.

The gift queue unit 208 may be configured to control the gift queue DB 222. In some embodiments, if the input transmit unit 206 fails to realize the gift sending function, such as transmit the gift information to the server 10, during the period of outage, the gift queue unit 208 may store the gift information in the gift queue DB 222. In some embodiments, if the outage is ended or the gifting function is fixed, the gift queue unit 208 may transmit the gift information in the gift queue DB 222 to the server 10 for realizing the gift sending function.

In some embodiments, the gift queue unit 208 may transmit all gift information in the gift queue DB 222 at once and delete all gift information in the gift queue DB 222. In some embodiments, the gift queue unit 208 may transmit a portion of the gift information in the gift queue DB 222 for each time and delete the corresponding gift information in the gift queue DB 222.

In some embodiments, some actions performed by the users may require the user to consume a certain amount of points or coins. The points or coins may be purchased by the user in the APP or platform. In some embodiments, the actions may include purchasing a gift, voting a streamer, purchasing a membership, purchasing a title, supporting the streamers or the like. In some embodiments, if the user terminal of the viewer has enough points, the gift queue unit 208 may transmit all the gift information in the gift queue DB 222 to the server 10. In some embodiments, if the user terminal of the viewer does not have enough points, the gift queue unit 208 may access the viewer to an in-app purchase page for purchasing enough points to send out gifts.

During the period of outage, there is a possibility that the in-app purchase page does not work appropriately. If the viewer does not have enough points but would like to send gifts during outage, the gift queue unit 208 may store the gift information in the gift queue DB 222 in advance and access the viewer to the in-app purchase page when the outage is ended. According to the embodiments, the viewer may still perform the operation of sending gifts to show support to streamers during the period of outage.

In a live streaming, the viewer may spend a specific amount of points to send a gift to the streamer, and the streamer may receive corresponding reward to encourage the streamer's performance. For example, if the viewer sends a gift with 1000 points, the streamer may receive the gift with 1000 points as the reward. In some embodiments, the gifts sent during the period of outage may cause more rewards as a compensation to the viewers, streamers or the like. For example, if the viewer sends a gift with 1000 points, the streamer may receive the gift with 1200 points or more as the reward. According to the embodiments, the APP or platform may compensate the viewer and streamer for suffering from the outage and the compensation may motivate the viewer to send more gifts. In some embodiments, the gifts sent during an outage may have a discount or refund. For example, if the viewer sends a gift with 1000 points, the viewer will be charged only 800 points or the like. In some embodiments, the compensation may be determined according to the level of the user. In some embodiments, the compensation may be determined flexibly.

The sync unit 210 may be configured to synchronize information among the viewers and streamer. In some embodiments, the sync unit 210 may establish a connection between the viewer and streamer. In some embodiments, the sync unit 210 may synchronize the gift information in gift queue DB 222 from the viewer with the streamer, so the streamer may know the gifts the streamers will receive after the outage. According to the embodiments, the streamer may know the gifts the streamer will receive, so the user experience may be enhanced.

In some embodiments, the sync unit 210 may establish a connection between the viewer and the other viewers. In some embodiments, the sync unit 210 may synchronize the gift information in gift queue DB 222 from the viewer with the other viewers, so the viewer may know the gifts the other viewers will send after the outage. According to the embodiments, the viewers may know the gifts the other viewers will send, so it may motivate the viewers to send more gifts in order to show their support to the streamer.

In some embodiments, the connection may be a strong connection realized by the technology of WebSocket or the like. In some embodiments, the connection may be established when the viewer enters a live streaming room. In some embodiments, the connection may be established when an outage happens or the like. In some embodiments, the strong connection may be established among the viewer and the streamer. In some embodiments, the strong connection may be established between the viewer and the streamer only.

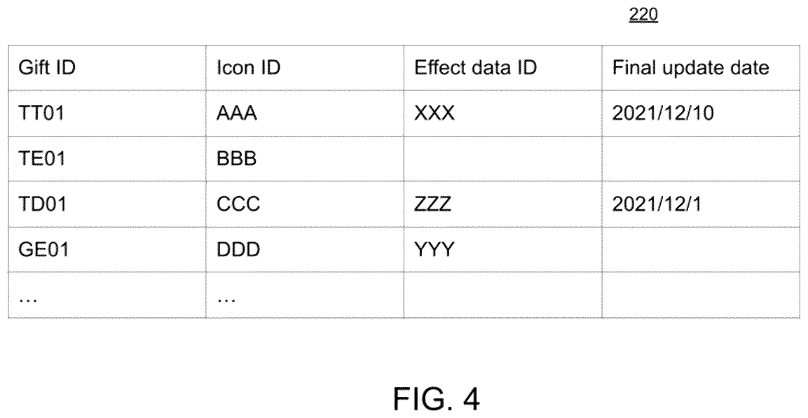

The terminal side gift DB 220 is configured to store the gift information of the user terminal 20 or 30. FIG. 4 shows an exemplary data structure of the terminal side gift DB 220 of FIG. 2. The terminal side gift DB 220 may include gift ID, icon ID, effect data ID and final update date. The gift ID may identify the gift. The Icon ID may be the icon data of the gift object. The effect data ID may identify the data realizing the effect corresponding to the gift. The final update date may identify the final update date of the gift.

In some embodiments, the viewer may download the gift in advance or download the gift when sending gifts. In some embodiments, gift information may be downloaded and stored in the terminal side gift DB 220 in advance. Therefore, the viewer may open the gift list and select the gift to be sent even if the gifting function does not work normally in the server 10.

In some embodiments, the terminal side gift DB 220 may include the gift list corresponding to the gift list provided by the server 10. In some embodiments, the gift list in the terminal side gift DB 220 may be synchronized with the server 10 periodically or by an operation from the user.

However, the terminal side gift DB 220 may not be able to synchronize with the server 10 during an outage. In some embodiments, the terminal side gift DB 220 may include general gift information, and all the gifts sent by the viewer may be displayed according to the general gift information. For example, the general gift information may include a gift box. If a viewer sent a diamond gift, the gift box may be shown instead of showing the effect corresponding to the diamond gift. According to the embodiments, some effect may be shown if the viewer sends a gift even if the gifting function does not work, so the user experience may be improved.

The gift queue DB 222 is configured to store the gift queue of the gift information sent by the user terminal 30. FIG. 5 shows an exemplary data structure of the gift queue DB 222 of FIG. 2. The gift queue DB 222 may associatively store the order and gift ID. The order may be the order of the gift to be sent by the viewer. The gift ID may identify the gift. The gift queue unit 208 may store the gift queue in the gift queue DB 222 and display an effect corresponding to the operation of gift sending.

A gift is electronic data with the following characteristics:
It can be purchased in exchange for the points (later described in detail) or can be given for free.
It can be given by a viewer to a streamer.—Giving a gift to a streamer is referred to as using the gift or throwing the gift.
Some gifts may be purchased and used at the same time, and some gifts may be purchased or given and then used at any time later by the purchaser or recipient viewer.
When a viewer gives a gift to a streamer, the streamer is awarded the amount of points corresponding to the gift and an effect associated with the gift is exerted. For example, an effect corresponding to the gift will appear on the live-streaming screen.

The effect is a visual or auditory or tactile effect (e.g., vibration) or a combination thereof that characterizes a gift. Examples of the visual effect include animation, images, and flashing/blinking. Examples of the auditory effect include sound effects and voice. The effect data is data for realizing such an effect on the user terminal 20, and the user terminal 20 realizes such an effect by processing the effect data. Since the technique for realizing the effect data itself is known, it will not be hereunder described in detail.

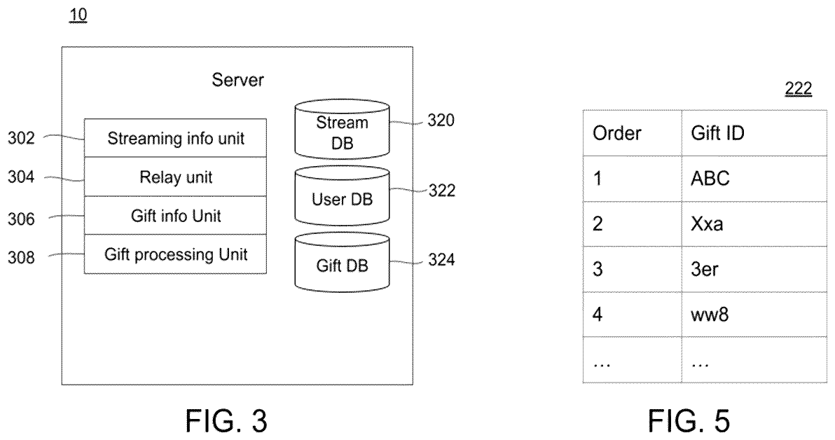

FIG. 3 is a schematic block diagram of the server 10 according to some embodiments of the subject application. The server 10 may include streaming info unit 302, relay unit 304, gift handling unit 306, gift processing unit 308, stream DB 320, user DB 322 and gift DB 324.

The streaming info unit 302 receives the request of live streaming from the user terminal 20 of the streamer via the network NW. Once receiving the request, the streaming info unit 302 registers the information of the live streaming on the stream DB 320. In some embodiments, the information of the live streaming may be the stream ID of the live streaming and/or the streamer ID of the streamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the streamer ID of the stream ID.

The relay unit 304 may relay the transmission of the live streaming from the user terminal 20 of the streamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the streamer ID of the streamer, who delivers the live streaming the viewer is viewing, and object ID specified by the object. If the object is a gift or the like, the object ID may be the gift ID or the like. Similarly, the relay unit 304 may receive the signal indicating the user input of the streamer, for example the object-designated signal, from the streaming unit 100 of the user terminal 20 while the streaming data is reproducing.

The gift info unit 306 provides information on gifts to the corresponding streamer and viewers. The gift info unit 306 transmits, to the streamer, the gift information for the terminal in response to a request from the user terminals. The gift info unit 306 obtains, from the gift DB 324, the effect data corresponding to the gift ID included in the gift information signal that has been received by the relay unit 304. The gift info unit 306 transmits the obtained effect data to the other user terminals 20 and 30 as a response to the gift sending request signal.

The gift processing unit 308 updates the user DB 322 so as to update the points of the streamer and the viewer depending on the points of the gift identified by the gift ID included in the gift usage signal. Specifically, the gift processing unit 308 refers to the gift DB 324 to specify the points to be granted for the gift ID included in the received gift usage signal. The gift processing unit 308 then updates the user DB 322 to add the determined points to the points of the streamer ID included in the gift usage signal. In some embodiments, the gift processing unit 308 may also update the user DB 322 to subtract the determined points from the points of the viewer ID included in the gift usage signal.

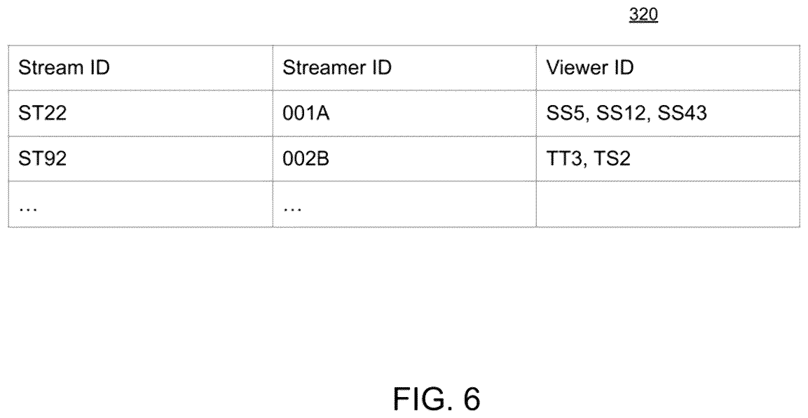

FIG. 6 shows an exemplary data structure of the stream DB 320 of FIG. 3. The stream DB 320 holds information regarding a live stream currently taking place. The stream DB 320 stores a stream ID for identifying a live-stream on a live distribution platform provided by the live-streaming system 1, a streamer ID for identifying the streamer who provides the live-stream, and a viewer ID for identifying a viewer of the live-stream, in association with each other.

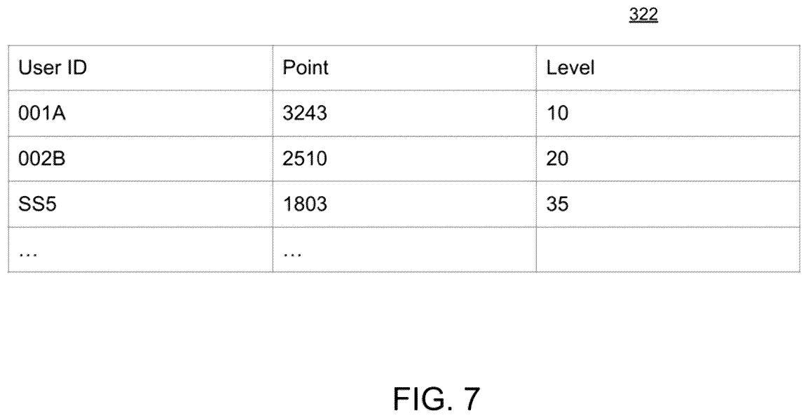

FIG. 7 shows an exemplary data structure of the user DB 322 of FIG. 3. The user DB 322 holds information regarding users. The user DB 322 stores a user ID for identifying a user, points that the user has, in association with each other. The point is the electronic value circulated within the live-streaming platform. When a streamer receives a gift from a viewer during a live stream, the streamer's points increase by the value of the gift. The points are used, for example, to determine the amount of reward or money the streamer receives from the administrator of the live-streaming platform.

In some embodiments, the user DB 322 may store the level of the user. The level is an indicator of the amount of user activity on the live-streaming platform. The level of the user is raised by giving gifts as a viewer, performing live-streams as a streamer, participating in events, and the like. The server 10 calculates the level of the user from the history of the user's activity.

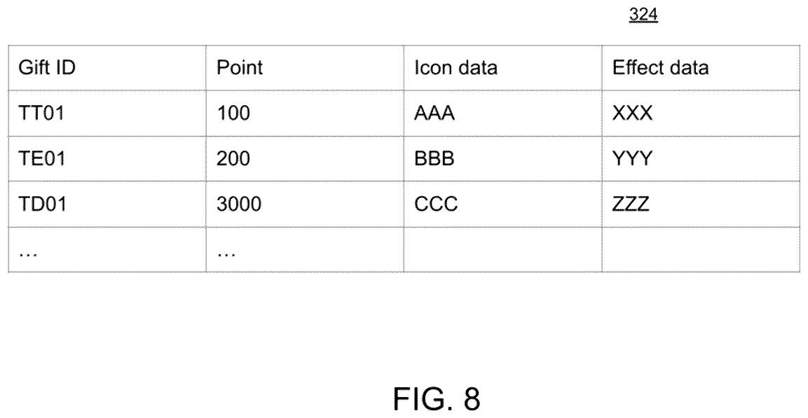

FIG. 8 shows an exemplary data structure of the gift DB 324 of FIG. 3. The gift DB 324 stores the icon data and the effect data of all gifts. The gift DB 324 stores a gift ID for identifying a gift, the amount of points that are granted to a streamer when the gift is given to the streamer, the icon data for the gift, and the effect data for the gift, in association with each other.

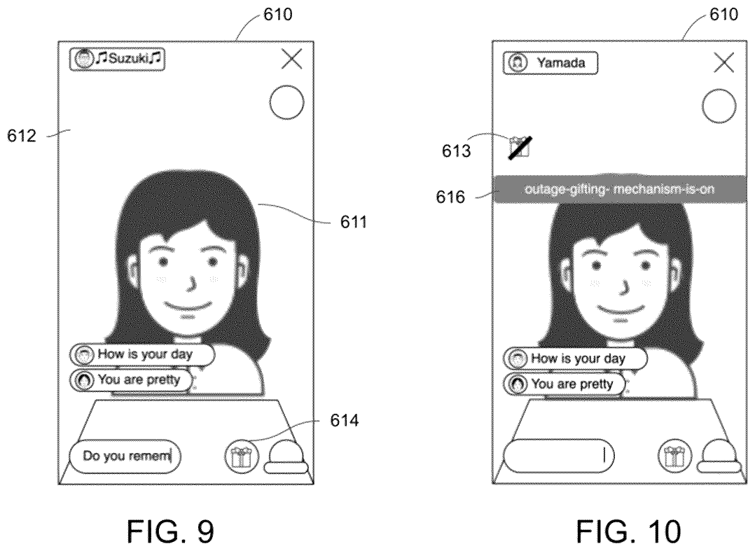

FIG. 9-FIG. 18 are exemplary screen images of a live-streaming room screen 610 shown on the display of the streamer user terminal 20 or the viewer user terminal 30.

FIG. 9 is an exemplary screen image of a live-streaming room screen 610 shown on the display of the viewer user terminal 30. Once the viewer selects and enters a live-streaming room, a live-streaming room screen 610 of the streamer may be shown on the display. The live-streaming room screen 610 includes a streamer image 611, room status object 612 and gift object 614. The streamer image 612 may be obtained by reproducing the video data. The room status object 612 may include information related to the current status of the live-streaming room. For example, the room status object 612 may include the icon showing the network connection. The room status object 612 may include the information, such as an outage, to indicate which function does not work currently. For example, if the service encounters an outage and the gifting function does not work, the room status object 612 may include an icon 613 to indicate that the gifting function does not work currently. In some embodiments, the room status object 612 may include a corresponding icon if the user-following function, voting function or the like do not work currently.

The gift object 614 may be the object for the viewer to tap in order to send a gift to the streamer. In a normal gift sending scenario, if the gift object 614 is tapped and a gift list may be shown on the screen 610. If a gift is selected and sent to the streamer. The input transmit unit 206 may generate gift information and transmit to server 10. After receiving the gift information, the gift info unit 306 may collect the gift information and transmit related information to the streamer and/or the other viewer, and the gift processing unit 308 may update the corresponding information in user DB. Therefore, the effect associated with the gift the viewer sent may be shown on the user terminal of the viewer and streamer, and the gift sending function may be realized.

In some embodiments, the server 10 may encounter outages and cause some functions not to work appropriately. For example, the gifting function, user-following function or voting function may not be able to be realized during outage. FIG. 10 is an exemplary screen image of the live-streaming room screen 610 shown on the display of the viewer user terminal 30. As shown in FIG. 10, the room status object 612 may show an icon to indicate that the gifting function does not work currently due to an outage or the like. In some embodiments, a text object 616 may be shown on the screen 610 to notify the user of the current status. In some embodiments, another mechanism such as “outage-gifting mechanism” may be triggered as an alternative to the gift sending function. In some embodiments, the text object 616 may include text such as “outage gifting mechanism is on” to indicate the outage-gifting mechanism is on. In some embodiments, the streamer and the viewer may be notified according to the text object 616 so that they can start encouraging their audience to keep sending gifts.

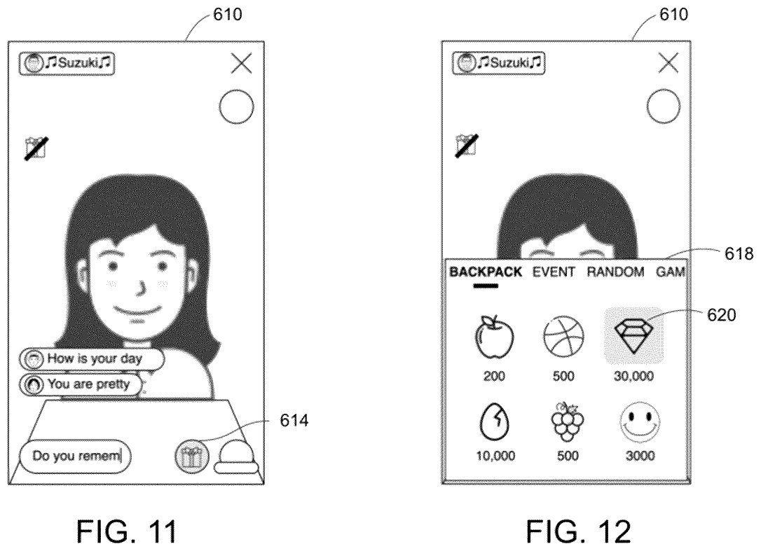

FIG. 11 and FIG. 12 are exemplary screen images of the live-streaming room screen 610 shown on the display of the viewer user terminal 30. During outages, the viewer may still see the gift and click the gift they would like to send. In FIGS. 11 and 12, the viewer may tap the gift object 614 and a gift list 618 may be displayed on the screen 610. The gift list may include a plurality of gift 620, and the viewer may select a gift 620 to send to the streamer. In some embodiments, the gift list 618 may be the same as the gift list in normal gift sending scenarios. More specifically, since the gift list may be cached or downloaded in advance, the gift list may also be used in the outage-gifting mechanism. In some embodiments, the gift list 618 may be different from the gift list in normal gift sending scenarios. In other words, there may be special gifts during outage, and the special gifts may be designed according to the practical need. In some embodiments, the special gifts may be provided or pre-downloaded from server 10 or the like.

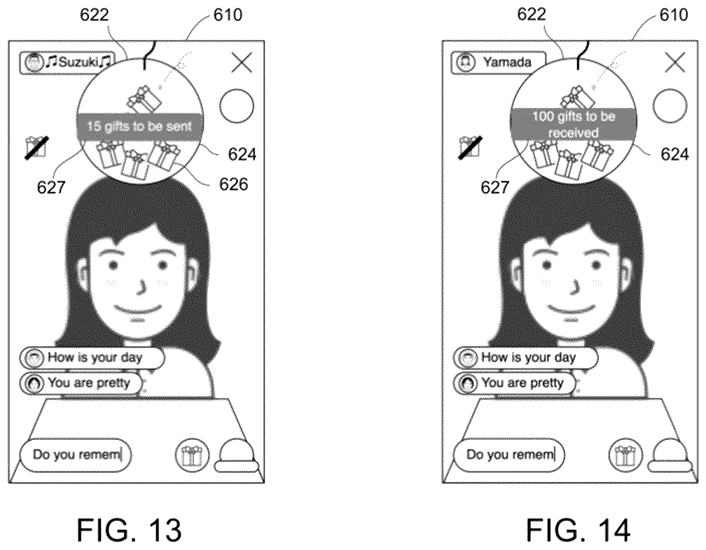

In some embodiments, if the gifting function does not work, the gift the viewer would like to send may be stored in the gift queue DB 222 and a corresponding effect may be shown on the user terminal. In some embodiments, some gift-related data may be pre-downloaded or cached in advance. FIG. 13 and FIG. 14 are exemplary screen images of the live-streaming room screen 610 shown on the display of the viewer user terminal 30 and the streamer user terminal 20 respectively. As shown in FIG. 13, if the viewer sends a gift 620 to the streamer during the outage of the gifting function, a gift object 622 may be shown on the screen 910. According to the embodiments, the viewer may know that the gift would be sent after the outage, so the user experience is improved.

In some embodiments, the gift object 622 may include a gift container 624 and a gift item 626. The gift container 624 may keep the gift item 626 and the gift item 626 may be corresponding to the gift the viewer sends. As shown in FIG. 13, the gift container 624 may be shown on the top of the screen 910, such as a big pinata, containing those gift items 626 to be sent. In some embodiments, the gift container 624 may be a hollow ball, a trunk, a pot, a Xmas tree or the like. In some embodiments, the gift item 626 may be shown during the outage so the viewer or the streamer may know that the gift is on the queue to be sent or received.

The gift item 626 may be a default icon such as a gift box to indicate the gift the viewer sends. In some embodiments, the gift item 626 may be the gift icon of the gift the viewer sends. For example, the viewer may send a diamond gift and an icon of diamond may be shown in the gift container 624. In some embodiments, the gift object 622 may further include a text object 627 to indicate the number of the gifts the viewer would like to send. In some embodiments, the gift container 624 may become bigger and bigger with the increase of the number of the gifts. In some embodiments, the viewer may cancel the gift item 626 by performing an operation, such as tapping on the gift item 626 or the like.

As shown in FIG. 14, the gift object 622 may be shown on the streamer user terminal 20. More specifically, the sync unit 210 may synchronize information between the viewer and the streamer, so the gift information in gift queue DB 222 of the viewer may be synchronized with the streamer user terminal 20. In some embodiments, an effect corresponding to the gift information may be displayed on the screen 910 of the streamer user terminal 20. For example, a corresponding gift object 622 may be shown on the streamer user terminal 20 according to the gift information from the viewer user terminal 30.

In some embodiments, the streamer may receive the gift information from different viewers. The effects corresponding to the gift information from different viewers may be displayed together or separately. The gift object 622 in the streamer user terminal 20 may include more than one gift object 622, and each gift object 622 may show the gift container 624 and gift item 626 separately from different viewers. For example, there may be five gift objects 622 that show the top five gift senders respectively. According to the embodiments, the viewer may know the number of gifts sent by the other viewers, and it may motivate the viewer to send more gifts to compete with other viewers and to support the streamer.

In some embodiments, the streamer user terminal 20 may include one gift object 622 to show all the gift information from different viewers. For example, the gift object 622 may include one gift container 624 to keep a plurality of gift item 626 from different viewers. In some embodiments, the gift object 622 may also include a text object 627 to indicate a total number of gifts from different viewers. According to the embodiments, the streamer may know that the gift would be received after the outage, so the user experience is improved.

In some embodiments, the gift object 622 may be displayed as a shopping cart for the viewer. The viewer may know what gifts the viewer has selected to be sent after the outage. Since the gift information in the gift object 622 may be synchronized with the streamer, the corresponding gift object 622 may also be displayed as the viewer's shopping cart. The streamer may know what gift the viewer has selected to send to the streamer according to the shopping cart. Therefore, even during an outage of the gifting function, the viewer and the streamer may be satisfied and the user experience may be improved. Moreover, the streamer may know the gift information from different viewers, so it may help the streamer understand the viewer more.

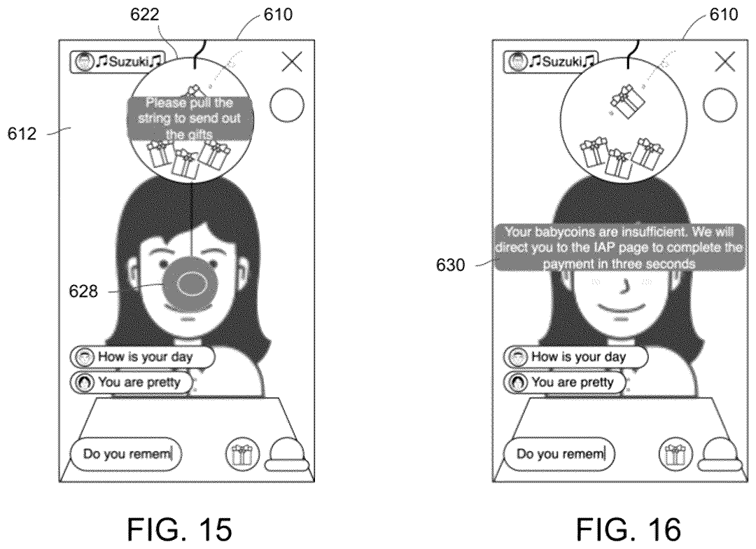

FIG. 15 is an exemplary screen image of a live-streaming room screen 610 shown on the display of the streamer user terminal 20. If the outage is ended, the room status object 612 may be updated to notify the user that the gifting function goes back to normal. As shown in FIG. 10 and FIG. 15, the icon 613 may disappear to notify the streamer and the viewers that the gifting function goes back to normal. After the outage is ended, the gift queue unit 208 may transmit the gift information from the gift queue DB 222 to server 10 to realize the gifting function.

In some embodiments, the gift queue unit 208 may transmit the gift information to server 10 manually or automatically. For example, the gift queue unit 208 may transmit the gift information to server 10 automatically once the outage is ended. In some embodiments, the gift queue unit 208 may transmit the gift information to server 10 according to an operation from the viewer. For example, a gift sending list may be shown after the outage to notify the viewer what gifts the viewer is going to send, the viewer may confirm or cancel each gift by performing an operation such as clicking a button or the like. In some embodiments, if the viewer does not have enough points to send the gift, the viewer may also be accessed to an in-app purchase page to purchase points.

In some embodiments, an object 628 may be shown on the screen 910 once the outage is ended. The streamer or the viewer may perform an operation on the object 628 to trigger the gift queue unit 208 to realize the gifting function. As shown in FIG. 15, an object 628 such as a handle with a string descending from the bottom of the gift object 622 may be shown on the screen 910. The streamer or the viewer may tap or pull down the handle to receive or send the gift which is kept in the gift object 622.

FIG. 16 is an exemplary screen image of a live-streaming room screen 610 shown on the display of the viewer user terminal 30. As shown in FIG. 16, a text object 630 may be shown to indicate that the viewer may not have enough points to send all the gifts in the gift object 622. In some embodiments, the purchase function may not be able to work during an outage. For example, the viewer may not be able to purchase the gift or purchase the points to send gifts or vote in an event. In some embodiments, the viewer may select a gift to be sent even if the points of the viewer are not enough. After the outage is ended and all the function goes back to normal, the viewer may be accessed to an in-app purchase page if the points the viewer has are not enough to send the gifts in the gift queue DB 222. In some embodiments, if the viewer purchases enough points, the gift queue unit 208 may transmit the gift information to server 10 to realize the gifting function. In some embodiments, if the viewer does not have or purchase enough points, all or a portion of the gifts in the gift queue DB 222 may be discarded or canceled, stop

In some embodiments, if the viewer sent a gift during an outage, the gift information may be stored in the gift queue DB 222. If the viewer stops watching the live stream and leaves the live streaming room during/after the outage without completing the outage gifting process, the gift in the gift queue DB 222 may be discarded or canceled. In some embodiments, the gift in the gift queue DB 222 may be stored and kept until the next time the viewer enters the live streaming room of the streamer. In some embodiments, the gifts may also be sent as an offline gift, which means that the gift may also be sent even if the viewer is not in the live streaming room. More specifically, the gift sending function or the purchase function may also be realized out of the live streaming room. For example, the viewer may confirm the gift or purchase the points once the viewer login in the app or the like. The gift sending may be realized once the viewer finished all and the gift sending and purchase process out of the live streaming.

In some embodiments, an expiration time may be set to the gift sent during the outage. For example, if the viewer sends a gift during an outage, the gift information may be transmitted to the server 10 after the outage. The server 10 may access the viewer to an in-app purchase page for purchasing enough points or transmit the information for the viewer to complete the gift sending. If the viewer does not complete the process in a specific time, the gift may be discarded or canceled. The process may be completed in the streaming room or out of the streaming room. In some embodiments, the server 10 may inform the viewer and the streamer that the gift has been discarded or canceled. According to the embodiments, the server 10 may easily control the status of the gift sent during the outage.

In some embodiments, if the streamer stopped streaming during/after the outage without letting the viewer complete the outage gifting process, the gifts in the gift queue DB 222 may be discarded or canceled. In some embodiments, the gift in the gift queue DB 222 may be stored and kept until the next time the streamer starts the live streaming. In some embodiments, the gifts may also be sent as an offline gift, which means that the gift may also be sent even if the streamer is not on broadcasting. For example, the live streaming of the streamer may be archived, the gifts may be sent to the streamer and the gift information such as gift effect may be reflected on the archive of the live streaming or the like.

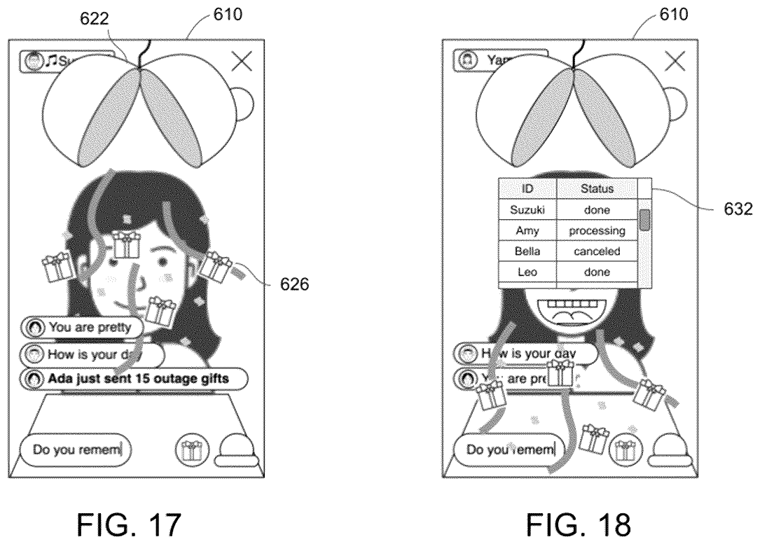

FIG. 17 is an exemplary screen image of a live-streaming room screen 610. Once the gift queue unit 208 transmits the gift information to server 10 to realize the gifting function, the gift object 622 may change accordingly to indicate that gifts are sent to the streamer. As shown in FIG. 17, a hollow ball with a plurality of gifts boxes may be opened and the gift item 626 may fall down to show that the streamer receives a plurality of gifts. In some embodiments, the effect of the gifts sent by the viewer may be shown one by one. In some embodiments, only the falling down of the gift item 626 may be shown if the streamer received too many gifts. In some embodiments, the effect of the gifts sent by the viewer may be combined into one effect to be shown on the screen 910. According to the embodiments, the situation of showing too much effect at the same time may be prevented and the user experience may be improved. In some embodiments, the viewer ID may also be shown together with the effect, such as on the gift item 626 or on the message zone. In some embodiments, all the viewers who contribute to the gift sending during outage may be shown with their viewer ID so that the streamer may know who is supportive.

In some embodiments, the streamer or the viewer may perform an operation on the gift item 626. More specifically, the streamer may tap on the gift item 626 when the gift item 626 is falling down to open the gift. In some embodiments, the viewers or the streamer may tap on the falling gift item 626 to collect extra reward, such as special gift or badge. The extra reward may be compensation for the user and it also motivates the user to enjoy the outage gifting mechanism.

FIG. 18 is an exemplary screen image of a live-streaming room screen 610. After the outage is ended, a list object 632 may be shown on the screen 910 to indicate whether the viewer sends the gift during outage and whether the viewer finished the purchase and the gift sending or not. The streamer may simultaneously see the information of viewers who have successfully sent gifts and viewers who have not yet completed the purchase or gift sending, so that the streamer may guide the viewer to complete the gift sending process. As shown in FIG. 18, a list object 632 may show on the screen 910 to inform the streamer of the current status. The list object 632 may include the user ID, the status of their gift sending during the outage or the like. According to the embodiments, it motivates the viewer to send gifts to the streamer, and the streamer may know the support from the viewer, and the user experience may be improved.

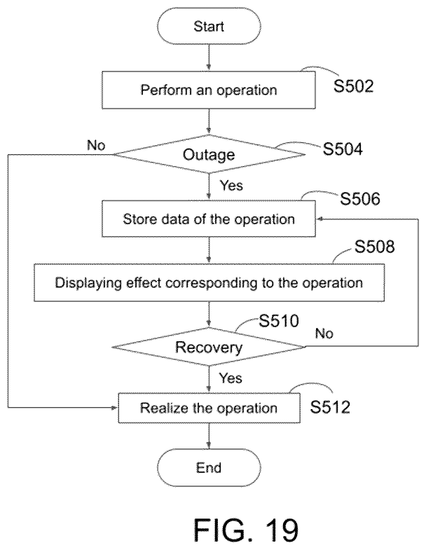

The operation of the live streaming system 1 with the above configuration will be now described. FIG. 19 is a flowchart showing steps of an application activation process on the user terminals 20 and 30. Once a user enters a live streaming room, the user may perform an operation by the user terminal to interact with a streamer (S502). In some embodiments, the operation may include commenting, sending gifts, following, unfollowing, voting, gaming or the like.

The user terminal may detect whether an outage occurs or not (S504). In some embodiments, the server 10 may inform the user terminal that the server 10 is during an outage. In some embodiments, the outage may be detected by performing the operation by the user terminal. For example, the operation may be to send a gift. The user terminal may detect that there is an outage if the user terminal fails to realize the gifting function over a specific number of times or a specific period. In some embodiments, the outage may be detected if the user terminal receives a specific response from server 10, or not received any response from server 10. For example, the user terminal may detect that there is an outage if the user terminal receives error messages of gift sending over a specific number of times, or not received any response from the server 10 over a specific period. In some embodiments, server 10 may also inform the user terminal of the outage.

If there is no outage (NO in S504), the user terminal may process the data for realizing the operation (S512). For example, if there is no outage and all the functions in the live streaming room are normal, the input transmit unit 206 may generate gift information and transmit to server 10 to realize the operation of gift sending. However, if there is an outage of at least one functionality in the live streaming room (YES in S504), the outage-gifting mechanism may be triggered. In some embodiments, server 10 may inform the user terminal to trigger the outage-gifting mechanism, for example, via a third-party service such as PubNub, Ably or the like. In some embodiments, the user terminal may store data of the operation in a database (S506). For example, the gift queue unit 208 may store the gift information of the gift in the gift queue DB 222.

Furthermore, the user terminal may display an effect corresponding to the operation on a display of the user terminal during the outage (S508). For example, the gift queue unit 208 may retrieve an effect from the terminal side gift DB 220 and display an effect on the display of the user terminal. Therefore, the user may know a gift is on the queue to be sent.

The user terminal may detect whether the outage is recovered or not (S510). In some embodiments, the server 10 may inform the viewers and streamers that the outage is recovered. In some embodiments, the recovery of the outage may be detected by performing the operation by the user terminal. For example, the user terminal may detect that the outage is recovered if the user terminal successfully sends out the gift. In some embodiments, the recovery may be detected if the user terminal receives a specific response from server 10. For example, the user terminal may detect that the outage is recovered if the user terminal receives recovery messages or gifts sending successful messages from the server 10. In some embodiments, the happen and recovery of the outage may all be informed by the server 10, so that the information and the time trigger the outage-gifting mechanism may be more correct.

If the outage is not recovered (NO in S510), the user terminal stores data of the operation in a database and displays an effect corresponding to the operation. On the other hand, If the outage is recovered (YES in S510), server 10 may inform the user terminal to close the outage-gifting mechanism, for example, via a third-party service such as PubNub, Ably or the like. In some embodiments, the user terminal may process the data for realizing the operation (S512). For example, the gift queue unit 208 may retrieve the data from the gift queue DB 222 and transmit to server 10 to realize the gift sending.

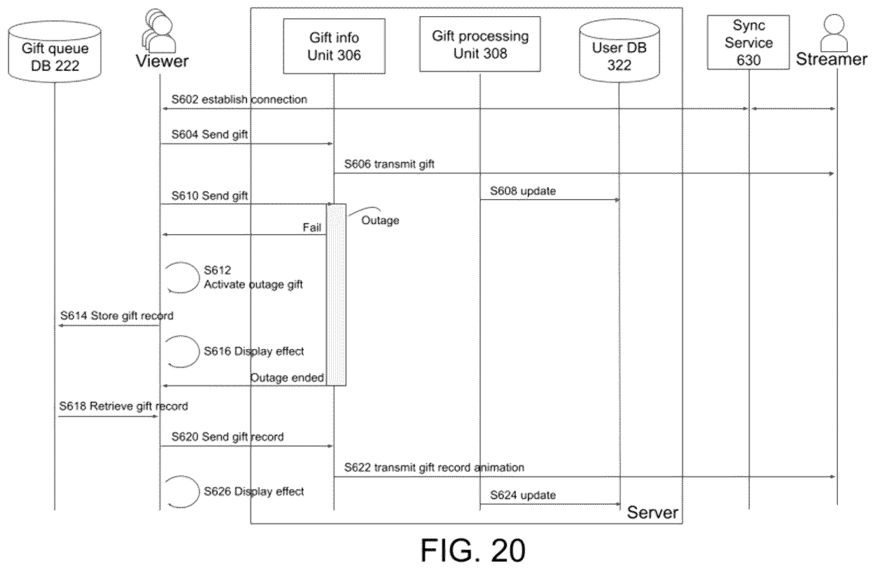

FIG. 20 is an exemplary sequence chart illustrating an operation of the configuration of the live streaming system 1 according to some embodiments of subject application. In some embodiments, an operation performed by the viewer may be to send a gift. As shown in FIG. 20, a connection may be established between a viewer and a streamer (S602). In some embodiments, the connection may be established by a sync service 630. In some embodiments, the connection may be like a chatroom for the viewers and streamer to synchronize the information with each other. In some embodiments, the connection may be established among all the streamers and viewers in the streaming room, so that the information may be synchronized with each user. In some embodiments, the connection may be established when the viewer enters the live streaming room. In some embodiments, the connection may be a strong connection established via a third-party service, such as PubNub or Ably, or the like.

The viewer may perform an operation such as sending a gift to the streamer (S604). The input transmit unit 206 may generate gift information and transmit to the gift info unit 306 in server 10. If the gifting function is normal, the gift info unit 306 may transmit the gift information to the streamer (S606) and the gift processing unit 308 may update the user DB accordingly (S608). In some embodiments, the gift info unit 306 may transmit the gift information to the other viewers in the live streaming room so that the other viewers may understand that a viewer and a gift to the streamer.

In some embodiments, the viewer may send another gift to the streamer (S610). In some embodiments, the server 10 may have outages that cause the gifting function not to work normally. For example, the gift info unit 306 may not be able to transmit the gift information to the streamer or the like due to an outage. In some embodiments, the gift info unit 306 may transmit an error or failure message to notify the viewer that it fails to send the gift currently. If the user terminal of the viewer detects that there is an outage, then the user terminal may activate the outage gift mechanism (S612). The user terminal of the viewer may store the gift record (S614) and display an effect corresponding to the gift on a display of the viewer user terminal (S616). In some embodiments, since a connection between the viewer and the streamer is established, the viewer may synchronize the gift record with the streamer so an effect corresponding to the gift may also be displayed on a display of the streamer user terminal.

In some embodiments, if the outage is recovered, the gift info unit 306 may notify the viewer that the gifting function is fixed and goes back to normal currently. In some embodiments, the gift queue unit 208 may retrieve the gift record in gift queue DB 222 (S618) and send the gift record to the gift info unit 306 in server 10. The gift info unit 306 may transmit the gift record to the streamer (S622) to realize the gift sending function, and the gift processing unit 308 may also update the user DB accordingly (S624). In some embodiments, the user terminal of the viewer may display an effect corresponding to the gift sending on a display of the viewer user terminal (S626).

According to the embodiments, instead of showing an error message when sending a gift during outage, the viewer and the streamer may still send and receive gifts during outage. Moreover, the gift queue the viewer is going to send and the streamer is going to receive will be shown on the screen, so the viewer and the streamer may feel satisfied instead of feeling angry. Moreover, the gift queue is shown on the screen, so it motivates the viewer to send gifts in order to support the streamer, and it also motivates the streamer to cheer up the viewer too.

In some embodiments, the outage-gifting mechanism may also be applied when server 10 needs maintenance. For example, if some function in the server 10 needs a periodical maintenance to confirm the performance, the server 10 may trigger the outage-gifting mechanism to inform the user that the gifting function is on maintenance. According to the embodiments, the viewers and streamers may enjoy the live streaming even if a specific function is on maintenance. In some embodiments, if the viewer purchases a specific gift or combination of gifts in the gift container 624 during the outage, server 10 may also provide a special discount or extra reward for the compensation. In some embodiments, if the viewer keeps staying in the live streaming room and finished the transaction of the purchase right before the end of the streaming, server 10 may also provide extra reward to the viewer as a compensation.

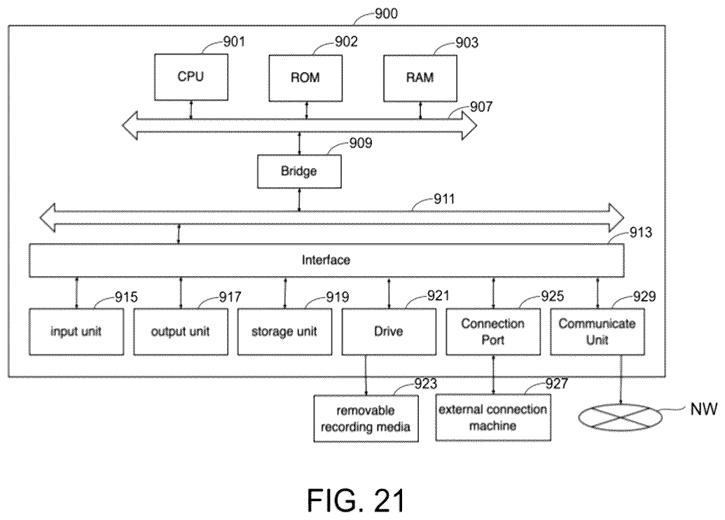

FIG. 21 is a schematic block diagram of computer hardware for carrying out a system configuration and processing according to some embodiments of subject application. The information processing device 900 in FIG. 18 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN). Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the streamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

LIST OF REFERENCE NUMBERS

| | | | |
|---|---|---|---|
| 1 | Live streaming system | 10 | Server |
| 20 | User terminal | 100 | Streaming unit |
| 102 | Video control unit | 104 | Audio control unit |
| 106 | Distribution unit | 108 | UI control unit |
| 200 | Viewing unit | 202 | UI control unit |
| 204 | Rendering unit | 206 | Input unit |
| 208 | Gift queue unit | 210 | Sync unit |
| 220 | Terminal side gift DB | 222 | Gift queue DB |
| 30, 30a, 30b | User terminal | 302 | Providing unit |
| 304 | Relay unit | 306 | Gift info unit |
| 308 | Gift processing unit | 320 | Stream DB |
| 322 | User DB | 324 | Gift DB |
| 610 | Screen | 611 | Streamer image 611 |
| 612 | Room status object | 614 | Gift object |
| 616 | Text object | 618 | Gift list |
| 620 | Gift | 622 | Gift object |
| 624 | Gift container | 626 | Gift item |
| 628 | Object | 630 | Text object |
| 900 | Information processing device | 901 | CPU |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording medium | 925 | Connection port |
| 927 | External connection device | 929 | Communication unit |
| LS | Live streaming | LV | Streamer |
| NW | Network | SP | Specific portion |

| | |
|---|---|
| AU1, AU2 | Viewer |
| S502, S504, S506, S508, S510 | Step |
| S602, S604, S606, S608, S610 | |
| S612, S614, S616, S618, S620 | |
| S622, S624, S626 | |
| VD, VD1, VD2 | Video |

What is claimed is:

1. A method, comprising:
detecting an outage of at least one functionality in a live streaming;
performing an first operation toward a second user terminal;
storing data of the first operation in a database of the first user terminal; and
displaying an effect corresponding to the first operation during the outage.

2. The method according to claim 1, further comprising:
processing the data for realizing the operation after a recovery of the outage automatically or based on a second operation from the first user terminal or the second user terminal.

3. The method according to claim 1, wherein
the operation includes a decrease of a first point from the first user terminal or an increase of a second point to the second terminal; and
the second point is the same as or higher than the first point.

4. The method according to claim 3, wherein
the operation includes a decrease of a first point from the first user terminal; and
receiving information for purchasing points after a recovery of the outage if the first point is higher than the point the first user terminal has.

5. The method according to claim 1, wherein
the effect includes an object corresponding to the operation; and
the object is shown during the outage.

6. The method according to claim 1, further comprising:
establishing a connection between the first user terminal and the second user terminal;
synchronizing the data of the operation from the first user terminal with the second user terminal.

7. The method according to claim 1, wherein
the operation includes commenting, sending gifts, following, unfollowing, voting, gaming or the like.

8. A method, comprising:
detecting an outage of at least one functionality in a live streaming;
receiving data of a first operation from a first user terminal;
displaying a first effect corresponding to the first operation during the outage.

9. The method according to claim 8, further comprising:
receiving data of a second operation from a second user terminal;
displaying a second effect corresponding to the second operation; wherein
the first effect and the second effect are displayed together or separately.

10. A non-transitory computer-readable medium including program instructions, that when executed by one or more processors, cause the one or more processors to execute:
detecting an outage of at least one functionality in a live streaming;
performing an first operation toward a second user terminal;
storing data of the first operation in a database of the first user terminal; and
displaying an effect corresponding to the first operation during the outage.
